(19) United States
(12) Patent Application Publication
(10) Pub. No.: US 2013/0225294 A1
(43) Pub. Date: Aug. 29, 2013

(54) DETECTING ILLEGAL MOVES IN A GAME USING INERTIAL SENSORS

(71) Applicant: Saad Bin Qaisar, Islamabad (PK)

(72) Inventor: Saad Bin Qaisar, Islamabad (PK)

(21) Appl. No.: 13/426,601

(22) Filed: Mar. 22, 2012

(30) Foreign Application Priority Data
Feb. 23, 2012 (PK) 117/2012

(51) Int. Cl. A63F 13/06; A63F 13/10; A63F 13/00

(52) U.S. Cl. CPC A63F 13/06; A63F 13/00; A63F 13/10
USPC 463/36; 463/43; 463/32

(57) ABSTRACT

Disclosed is a system for monitoring moves of a game player and for feeding inference to a visualization and actuation module, where the system comprises MEMS-based accelerometers and gyroscopes, and sensors to collect data and apply one or more classification algorithms to process the data. With the help of a decision metric, results of the algorithm are used to classify whether an action of the player is legal or illegal under the rule of the game.

### CROSS REFERENCE TO RELATED APPLICATION

The present Application is related to Pakistan Patent Application entitled “Detecting Illegal Moves in a Game Using Inertial Sensors,” filed 23 Feb. 2012 and assigned filing number 117/2012, incorporated herein by reference in its entirety.

### FIELD OF THE INVENTION

The present invention relates to gaming systems and, more particularly, to a system and method for detecting an illegal move made by a game player.

### BACKGROUND OF THE INVENTION

Many technologies have been used in the past for detecting illegal moves in games. Most of these systems involve cameras with an observer or a computer program for classifying the activity being monitored. A video processor may be configured to identify anomalous or abnormal behavior. For example, a system may treat stealing or shoplifting as abnormal behavior and use video feature extraction and model based comparison techniques for detecting anomalous behavior.

Other solutions may involve tracking players without using cameras but by monitoring key features and applying pattern recognition techniques for classifying a move. These solutions may execute on a computer based processing device to detect unwanted or unfair betting patterns of players. In this scenario, both known and unknown players may be tracked, wherein game data is collected over a plurality of gaming sessions and analyzed to determine if an alert needs to be triggered for an operator of the game. These systems may have applications in detecting illegal activity in gaming, gambling, or other operations with a high risk of potential fraud.

Sensor-based systems are becoming increasingly popular due to their low cost, miniaturized non-obtrusive form factor and higher accuracy. Sensor-based systems may detect contacts between the games equipment and a games object and/or contacts between a games object and a target surface. These systems may comprise sensor means that have been adapted to detect vibrations caused by game contacts and convert them into sensor data. These systems are generally focused on game contacts and not on the legality or illegality of action performed.

These systems have inherent limitation in terms of cost as they need expensive high-resolution cameras to cover all spatial aspects of a play for identifying key features accurately. A camera based approach requires complex computation methods to correctly estimate the location and attributes of the object under observation.

In contrast, inertial sensors may be used to accurately acquire the location, velocity, angular acceleration data or other attributes, processing the acquired data either in real-time or after the game is over. Inertial sensors are compact in size, portable, and low cost making them easy to use for determining the legality or illegality of a move as per the rules of a game. The accuracy achieved by logging movements using inertial sensors is better than the accuracy achieved by using camera-based systems because the location and viewing angle of a camera may become a limiting factor.

### BRIEF SUMMARY OF THE INVENTION

In one aspect of the present invention, a method for detecting illegal moves in a game comprises: sensing action of a player using at least one sensor on the player's body; transmitting sensor data from the at least one sensor to a base station; extracting features from the sensor data received at the base station; classifying the action of the player as a legal move or an illegal move using a clustering algorithm on the sensor data; and visualizing the result of the action, and providing a visualized result and a corrective feedback to an observer.

In another aspect of the present invention, an apparatus for classifying a player action as legal or illegal comprises: at least one sensing block for acquiring sensor data from the player; means for sending the sensor data downstream to a computation and inference block; means for receiving the sensor data at the computation and inference block; means for storing the sensor data received at the computation and inference block; means for processing the sensor data to develop inference on the legality of the player action; means for visualizing the player action based on the sensor data; and means for providing corrective feedback based on the inference.

In still another aspect of the present invention, an article of manufacture including a non-transitory computer-readable storage medium having instructions stored thereon which are executable by a computing device to cause the computing device to perform operations comprising the steps of: acquiring sensor data from at least one sensing block disposed on a player; sending the sensor data downstream to a computation and inference block; receiving the sensor data at the computation and inference block; storing the sensor data received at the computation and inference block; and processing the received sensor data to infer the legality of a player action performed in a game.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

Claimed subject matter is particularly pointed out and distinctly claimed in the concluding portion of the specification. However, both as to organization and/or method of operation, together with objects, features, and/or advantages thereof, may best be understood by reference to the following detailed description when read with the accompanying drawings in which:

FIG. 1 is a flow diagram of a system for detecting and visualizing a legal or illegal move using sensor data in accordance with one or more embodiments of the present invention;

FIG. 2 is a block diagram of a system of sensors that may be utilized for sensing moves, computing data, inferring results, and visualizing them in accordance with one or more embodiments of the present invention;

FIG. 3 is a diagrammatical illustration of a physical module of the sensors of FIG. 2; and,

FIG. 4 provides an exemplary embodiment of the placement of sensors on a player that may be used to classify game related actions.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding or analogous elements.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follows are presented in terms of algorithms, programs and/or symbolic representations of operations on data bits or binary digital signals within a computer memory, for example. These algorithmic descriptions and/or representations may include techniques used in the data processing arts to convey the arrangement of a computer system and/or other formation handling system to operate according to such programs, algorithms, and/or symbolic representations of operations.

An algorithm may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities.

Unless specifically stated otherwise, as apparent from the following discussions, it is appreciated that throughout the specification discussion utilizing terms such as processing, computing, calculating, determining, and/or the like, refer to the action and/or processes of a computer and/or computing system, and/or similar electronic computing device, that manipulate or transform data represented as physical, such as electronic, quantities within the registers and/or memories of the computer and/or computing system and/or similar electronic and/or computing device into other data similarly represented as physical quantities within the memories, registers and/or other such information storage, transmission and/or display devices of the computing system and/or other information handling system.

Embodiments claimed may include apparatuses for performing the operations herein. This apparatus may be specially constructed for the desired purposes, or it may comprise a general purpose computing device selectively activated and/or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMS), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device and/or other information handling system.

The processes and/or displays presented herein are not inherently related to any particular computing device and/or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments are not described with reference to any particular programming language. It will be appreciated that a variety of programming languages may be used to implement the teachings described herein.

In the following description and/or claims, the terms “coupled” and/or “connected,” along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other.

It should be understood that certain embodiments may be used in a variety of applications. Although the claimed subject matter is not limited in this respect, the system disclosed herein may be used in many apparatuses such as in training kits, performance logging systems, personal digital assistants, personal computers, laptops, handheld devices, cell phones, body mounted devices, local and wide area healthcare networks, and medical devices.

Types of wireless communication systems intended to be within the scope of the claimed subject matter may include, although are not limited to: Wireless Personal Area Network (WPAN), Wireless Local Area Network (WLAN), Wireless Ad Hoc Network, Wireless Wide Area Network (WWAN), Code Division Multiple Access (COMA) cellular radiotelephone communication systems, Global System for Mobile Communications (GSM) cellular radiotelephone systems, North American Digital Cellular (NADC) cellular radiotelephone systems, Time Division Multiple Access (TEMA) systems, Extended-TDMA (E-TOMA) cellular radiotelephone systems, third and fourth generation (3G/4G) systems like Wideband COMA (WCDMA), CDMA-2000, and/or the like, although the scope of the claimed subject matter is not limited in this respect.

Instructions as referred to herein relate to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. However, these are merely examples of an instruction, and the scope of the claimed subject matter is not limited in this respect.

Storage medium as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium, and the scope of the claimed subject matter is not limited in this respect.

The term “logic” as used herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA), for example. Also, logic may comprise machine-readable instructions stored in a storage medium in combination with processing circuitry to execute such machine-readable instructions. However, these are merely examples of structures which may provide logic, and the scope of the claimed subject matter is not limited in this respect.

Unless specifically stated otherwise, as apparent from the following discussion, it is appreciated that throughout this specification discussions utilizing terms such as processing, computing, calculating, selecting, forming, enabling, inhibiting, identifying, initiating, receiving, transmitting, determining and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, process described herein, with reference to flow diagrams or otherwise, may also be executed and/or controlled, in whole or in part, by such a computing platform.

Reference throughout this specification to one embodiment or an embodiment means that a particular feature, structure, or characteristic described in connection with the embodiment is included in at least one embodiment. Thus, the appearances of the phrase in one embodiment or an embodiment in various places throughout this specification are not necessarily all referring to the same embodiment. Furthermore, the particular features, structures, or characteristics may be combined in one or more embodiments.
As used herein, the term “game” refers to a form of recreational activity including any activity for diversion or amusement in a situation that may involve rules, goals, interaction, contest, competition, or rivalry. Some games may involve physical participants and sports implements. List of games may include all field games such as football, soccer, golf, rugby, basketball, polo, athletics, gymnastics, cricket; tabletop games such as card, board, tile-based games; and all others games having cyber-physical participants/components (e.g., human computer interaction in video games, internet based games, and robotic cups) involving a plurality of participants and sports implements.
A “player” as referred to herein relates to a participant in a game.
A “game animal” as referred to herein relates to any animal or machine being used by the player to play a game.
A “sports implement” herein refers to an implement that may be used in a game. Some examples of sports implement include but are not limited to batons, cue sticks, bats, pool cues, pool sticks, cue, poles, racquets, balls, and bars.
“Classification techniques” herein relate to all techniques based on artificial intelligence, data mining, machine learning, rule engines, ontologies, detection and estimation theory, statistical inference, computational statistics to name few to detect, and classify a plurality of states and/or hypotheses for an outcome of a situation.
“Sensor data” herein relates to information acquired through sensors. Acquired sensor data may be real time or non-real time. Similarly, the feedback data that may be played back (e.g., visualized) at a later time may be real time or non-real time.
Wherein an observer may generally be considered to be any user of a system who is interested in observing sensor data and/or the inferences obtained from the sensor data using a system. Therefore, an “observer” may comprise a game coach, trainer, referee, regulator, player, robotic machine, less-abled athletes or any other actors involved in a game in any form, directly or indirectly.

At times, game officials are not sure about the legality of a player's actions) under rules of a game. It may be that a player may have a unique playing style. It is common for some players to argue that their action is not illegal, despite having been questioned by the game officials or a regulatory body. This necessitates a system for determining movements of a game player or a plurality of game players, sport implements, sport animals or machines in order to correctly characterize the legality of actions.

The disclosed embodiments provide multiple ways to determine the legality of an action based on sensor data and are being supported by a three-dimensional visualization module for a graphical representation of the game data.

The disclosed embodiments test the legality of a player's action using the data acquired through sensors. In accordance with some embodiments, inertial sensors using a wireless technology, e.g., Bluetooth class 2 compatible wireless may be implemented to acquire data from the player. In an embodiment a player's presence in a scenario (e.g. field, room, laboratory, gaming zone, gymnasium, virtual world etc.) may be detected in a two-dimensional/three-dimensional space. In another embodiment, the acquired data may be stored in a data storage device (e.g., media such as storage disk, card, personal computer, personal digital assistant, phone, server) that may be easily transferred to a remote server. The acquired sensor data may be processed further for classifying actions as legal or illegal. One way to achieve this is by using a testing model. For this, sensor data may be acquired from IMUs (Inertial Measurement Unit), accelerometer and gyroscope before being pre-processed and refined prior to feeding to one or more classification algorithms.

According to one or more embodiments, data may be used to test correct action of the subject under study using any of the algorithms: K-means method, Markov chain model and hidden Markov model or a combination thereof. Any learning algorithms or decision techniques (e.g., rule based decision trees) may also be used if needed. All three algorithms are trained according to the real-time data acquired by the sensors and tested using a reference model. Application of these algorithms gives a reliable result on the legality of an action in a game situation.

According to one or more embodiments, the invention comprises a visualization module that may provide one or more observers a visual representation of the action. Once the data validation is complete, a specially designed module for two-dimensional or three-dimensional visualization may be used to identify the correct action. A two-dimensional or three-dimensional visualization is easier to understand and interpret not only for coaches and trainers of a game but also for novice observers of a game. In one embodiment, a module may project the pre-processed data and transform it into a two-dimensional or three-dimensional action figure model. This visualization may be used to provide corrective feedback to a player if found in violation of legal limits as it clearly indicates motion of different body parts whose monitoring is critical in assessing action's legality. Use of wireless sensors for data acquisition using wireless sensors for conducting action analysis and two-dimensional or three-dimensional visualization may be used to observe a player's moves from a remote location without requiring the player's presence at the analysis location.

In an exemplary embodiment, the invention may be utilized for training purposes in a game involving use of sports implement(s) for performance analysis of one or more players including but not limited to teaching an effective use of a sports Implement according to the one or more rules of a game in addition to using performance and/or biomechanical benchmarks.

According to one or more disclosed embodiments, a minimal number of sensors may be deployed on a player resulting in the player under test feeling more at ease in performing his regular actions. Therefore, an embodiment may use only a small number of light-weight sensors, placed according to the needs of the examiner, to test objects and their actions in a game accurately.

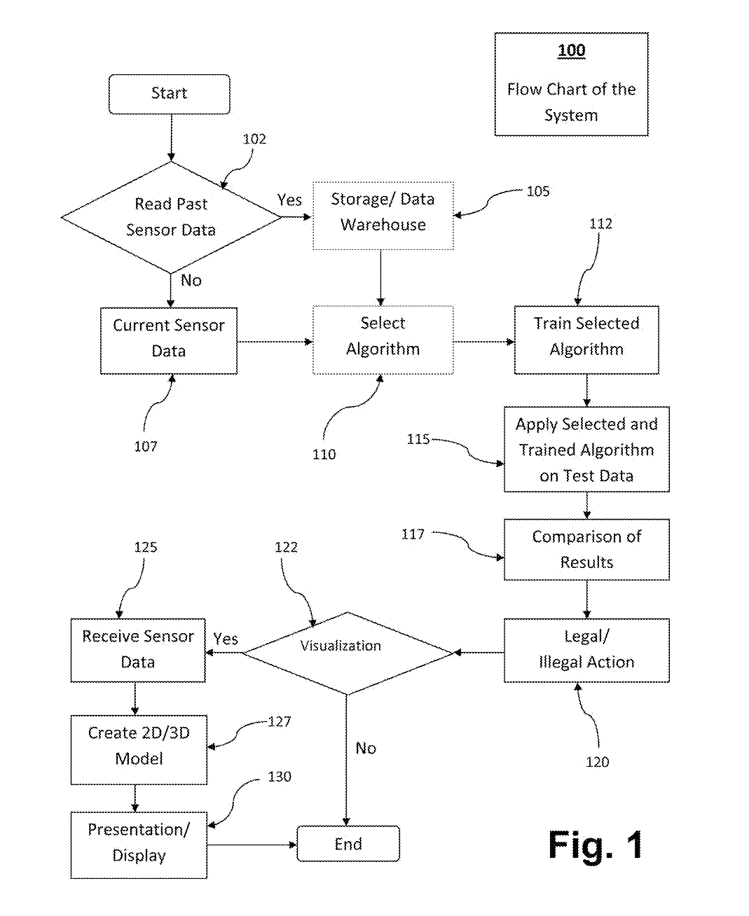

Referring now to FIG. 1, a flow chart 100 of the system in accordance with one or more embodiments as presented, will be discussed. In FIG. 1, the option for reading past sensor data may be chosen by 102, which if not preferred, permits the user to acquire the data from sensors directly at step 107. In an exemplary embodiment, if the option for reading the past sensor data was chosen at 102, the data from sensors that is stored in some storage device or data warehouse 105 may be acquired, which is then pre-processed and may be made ready for analysis by a classification algorithms. However, these are merely examples of how data may be acquired by the classification algorithm, and the scope of the claimed subject matter is thus not limited in this respect.

In an exemplary embodiment, one algorithm is selected at a time at step 110, and that algorithm is trained at step 112 on the basis of sensor data 105 or 107. In one or more exemplary embodiments, test data may be tested with one or more trained algorithms 112, at step 115 to analyze data. At step 117, results may be compared with the reference model of step 112 for conformity with rules of the game. At this stage 120, activity may be characterized as either legal activity or illegal activity.

In the embodiment illustrated in FIG. 1, 122 may be used for giving another option to user of the system, i.e. to generate a visualization of the play. In one or embodiments, a graphical activity model in two-dimensional or three-dimensional, resembling the real-time subject under study may be constructed at step 127 based on the acquired data for visual demonstration of the activity at step 125. The generated model is presented at step 130. An observer and/or a player may check for faulty movements, if any, and can adapt an athlete's training to comply with the rules of a game.

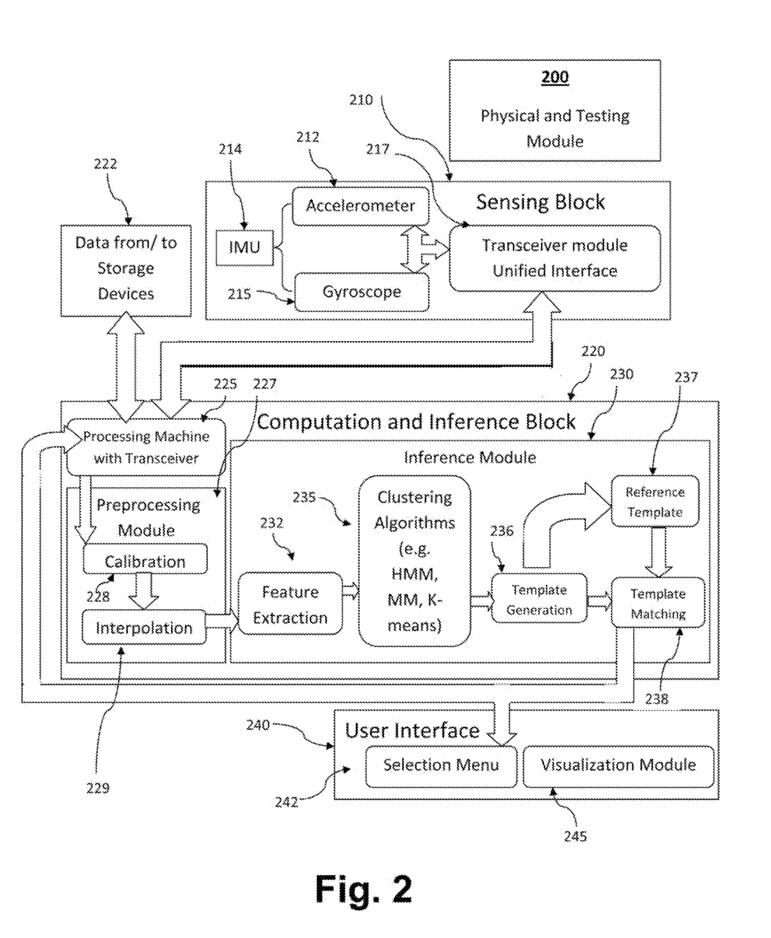

Referring now to FIG. 2, a diagrammatical illustration of the product in accordance with one or more embodiments will be discussed. The product as a system may comprise a plurality of physical and testing modules. As shown in FIG. 2 as one embodiment, the product may comprise a physical and testing module 200, which can be divided into one or more basic block types, e.g., a data sensing 210, a computation 220, and a visualization user interface 240. Each block type may further comprise sub-systems that may work in coordination with each other to ensure proper functioning of the entire block.

According to an embodiment, the sensing block 210 may represent a physical module or a dataset input to the algorithm. The breakdown of sensing block in an exemplary embodiment, is as follows: An Inertial Motion Unit (IMU) 214, comprising a gyroscope 215 and an accelerometer 212; and a unified transceiver module interface 217, comprising a computational module such as microcontroller with a device capable of transmitting/receiving data using a communications technology. e.g., Bluetooth class 2. However, any low-power, low-range, high-data rate transmission capable communication technology may be used since the data rate requirements are relatively low and an interface between the sensing block and the data storage device may include any computer device including a personal computer.

In one or more embodiments, data arriving from sensing block may be fed to a computation and inference block 220 through the processing machine with transceiver 225, into a preprocessing module 227 where it may be preprocessed or filtered. The data may be acquired from the transceiver module 217 or a storage medium or device 222. The data acquired from the physical module or storage device, may be noisy and raw. It may first be filtered utilizing signal processing techniques, then calibrated by a calibration module 228 against some set method, and then interpolated using an interpolation module 229 to produce meaningful results.

According to an exemplary embodiment, the output of preprocessing block may generate six-tuple data, triple axis (X, Y, Z) acceleration and angular velocity. Additional information may be obtained for further processing. This may be accomplished using feature extraction tool 232 in the inference module 230. In one or more embodiments, a plurality of features may be implementation comprising Mean, Mode, Standard Deviation, Peak to Peak Value, Minimum, Maximum, First and Second derivatives. These features may be evaluated at each data point and therefore may take a shape of a multi-axis waveform. The resulting wave may be fed to an algorithmic block 235.

Intelligent algorithms are required to successfully recognize an action with the help of a template generation block 236 according to one embodiment. A reference model 237 may be created based on a learning/decision making technique. In one implementation of the embodiment, unsupervised machine learning may be used instead of supervised learning eliminating the need for manual training of the system.

In an exemplary embodiment, several different clustering/learning techniques may be used including, but not limited to: K-means clustering, Hidden Markov Model (HMM), and Markov chain Models (MM) in the algorithmic block 235. Other algorithms may be deployed, such as, for example, supervised or unsupervised machine learning algorithms, rule-based decision systems, or classification techniques. However, these are merely examples of classification, clustering, and learning algorithms and the scope of the claimed subject matter is not limited in this respect. Finally, in one embodiment, the generated template may be matched with a reference template 238.

In an exemplary embodiment, after the algorithms have been successfully applied to the data, the processed sensor data may either be sent back to the storage device 222 via the processing machine 225 or it may be sent to a user interface 240 which allows the user to select the creation of two-dimensional or a three-dimensional visualizations using a selection menu. The visualization, as mentioned in the description of FIG. 1, may be done in a separate visualization module 245 shown in FIG. 2, and a corresponding two-dimensional or three-dimensional model may be created depicting movement of a player in a certain time frame, irrespective of player's acceleration and speed. According to one or more embodiments, any computer languages (e.g., C/C++), and graphics libraries (e.g., OpenGL), and other tools (e.g., three-dimensional StudioMax) may be used for creating three-dimensional illustrations for detecting, visualizing, and rectifying an illegal action, to the satisfaction of both the observers and players.

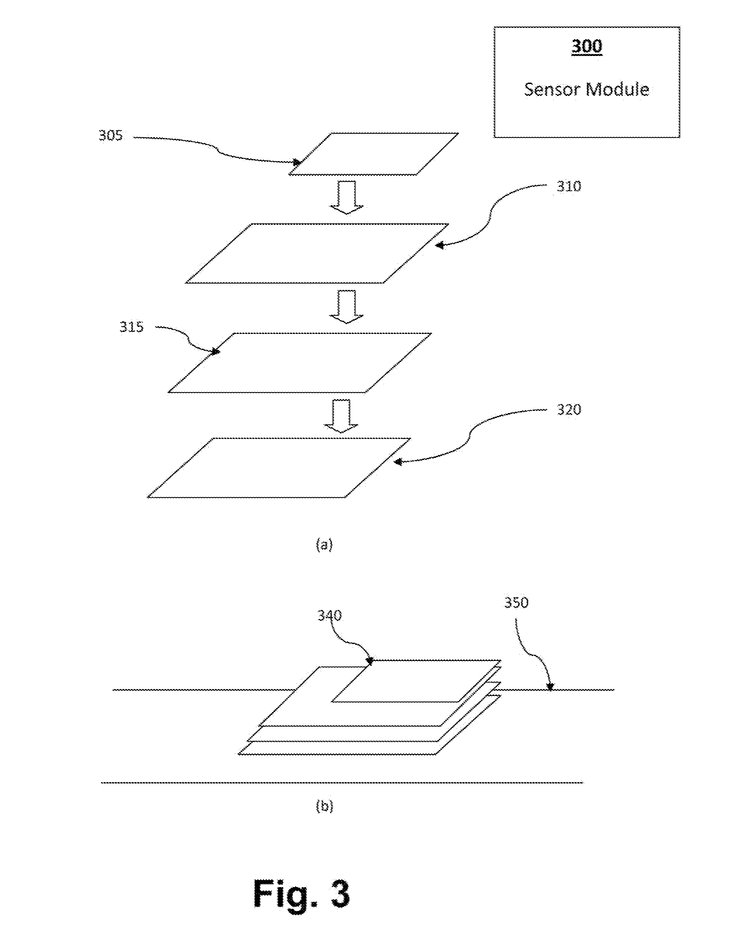

Referring now to FIG. 3, the structure of a sensor module 344 designed for acquiring sensor data in accordance with one or more embodiments will be discussed. FIG. 3 shows the structure of the sensor module 300 designed for acquiring the real-time data in this invention. In one embodiment, stacking of individual components in the sensor node is structured in parallel fashion; however, the individual components can be stacked together in alternate arrangements as well without compromising on functionality. Moreover, individual components used in this invention can either be combined with other components as desired, or can be replaced with different components to get an optimal functioning sensor node as desired.

The sensor module 300 comprises a battery casing 320 which may provide power to the sensor to ensure its safe operation, and a gyroscope board 315 having an accelerometer embedded on it, as well known in the relevant art. In an exemplary embodiment, a processor 310 controlling the transmission module and/or the sensor, is connected to the battery casing 320 for power supply, as well as to the gyroscope board 315, the accelerometer, and a Bluetooth class module 305, to ultimately combine to form a compact transmission module 340, capable of acquiring real-time data for analysis in this invention. The sensor module 300 may be designed in such a way so as to ensure that the player may face no hindrance while wearing the sensors to test the action.

In an exemplary embodiment, to ensure ease of wearing the transmission module, the sensor module 300 may be placed on an elastic strap 350, which is made of flexible material and may be used by a variety of players having comparatively different physiques.

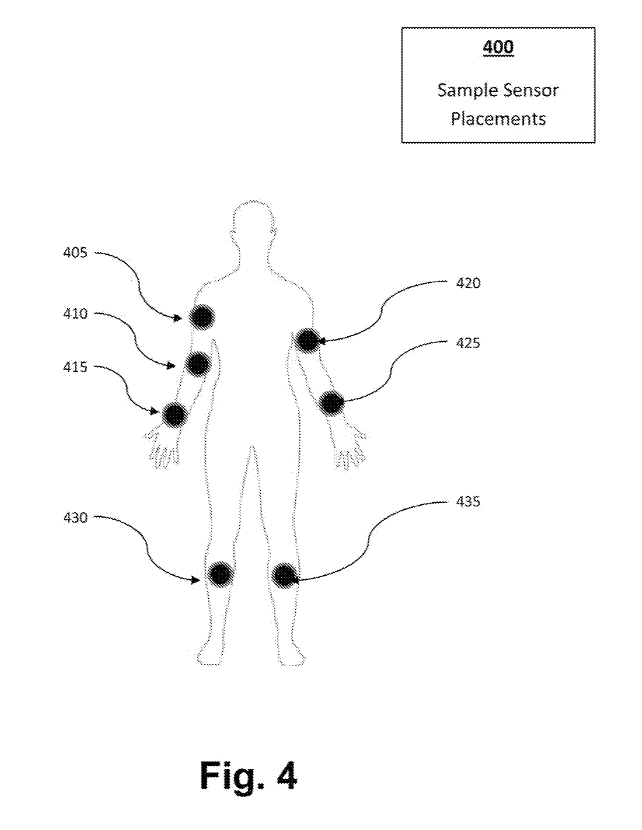

Referring now to FIG. 4, a sample placement 400 of the sensor module designed for acquiring sensor data in accordance with one or more embodiments will be discussed. A number of these sensor modules may be placed on the body of a player at locations of interest. In one embodiment, various possible sensor module placements are indicated in FIG. 4. A first sensor module placement 405 may be on an upper limb of a right arm, a second sensor module placement 410 for a right elbow, a third sensor module placement 415 for a right wrist, a fourth sensor module placement 420 for an upper limb of a left arm, a fifth sensor module placement 425 for a lower left arm, a sixth sensor module placement 430 for a right knee, and a seventh sensor module placement 435 for a left knee. The locations for sensors' or transmission modules' placement may be determined either through expert input (e.g., a biomechanics expert) or after conducting a number of experiments, to ensure a good visualization of test subject's actions, for optimal result processing and clear interpretation.

Although the claimed subject matter has been described with a certain degree of particularity, it should be recognized that elements thereof may be altered by persons skilled in the art without departing from the spirit and/or scope of the claimed subject matter. It is believed that detection of illegal actions under rules of a game using inertial sensors and/or many of its attendant advantages will be understood by the foregoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

It is to be further understood that the description herein is exemplary of the invention only and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

What is claimed is:

1. A method for detecting illegal moves in a game, said method comprising the steps of:
sensing action of a player using at least one sensor on said player's body;
transmitting sensor data from said at least one sensor to a base station;
extracting features from said sensor data received at said base station;
classifying said action of said player as a legal move or an illegal move using a clustering algorithm on said sensor data; and
visualizing the result of said action, and providing a visualized result and a corrective feedback to an observer.

2. The method of claim 1 further comprising the step of placing at least one sensor on a sports implement being used by said player in the game.

3. The method of claim 1 further comprising the step of placing at least one sensor on a game animal being used by said player the game.

4. The method of claim 1 wherein said clustering algorithm comprises at least one of a K-means clustering algorithm and a hierarchical Markov model algorithm.

5. The method of claim 1 said step of sensing is performed by a testing module operating using classification techniques for checking action under rules of the game.

6. The method of claim 1 wherein said step of sensing is performed by a physical module comprising at least one inertial sensor.

7. The method of claim 1 wherein said step of sensing is performed by a physical module capable of acquiring said sensor data using a wireless network of inertial sensors.

8. The method of claim 1 wherein said step of sensing is performed by a physical module functioning to acquire said sensor data in at least one of a real-time operation or in a storing operation for later use.

9. The method of claim 1 wherein said step of sensing is performed by a testing module to check player action for legality, according to the rules of the game.

10. The method of claim 1 wherein said step of classifying said action of said player comprises at least one of a supervised machine learning technique, a semi-supervised machine learning technique, or an unsupervised machine learning technique.

11. An apparatus for classifying a player action as legal or illegal, said apparatus comprising:
at least one sensing block for acquiring sensor data from the player;
means for sending said sensor data downstream to a computation and inference block;
means for receiving said sensor data at said computation and inference block;
means for storing said sensor data received at said computation and inference block;
means for processing said sensor data to develop inference on the legality of the player action;
means for visualizing the player action based on said sensor data; and
means for providing corrective feedback based on said inference.

12. The apparatus of claim 11 wherein said at least one sensing block comprises: an inertial measurement unit and a transmission module unified interface based on micro electro mechanical systems technology.

13. The apparatus of claim 11 further comprising a processor coupled to said at least one sensing block, and a memory medium coupled to said processor, wherein said memory medium includes program instructions stored thereon that are executable by said processor to cause said apparatus to transmit data using at least one of a wireless communication technology or a wired communication technology.

14. The apparatus of claim 11 further comprising a computation and inference block with a processor, and a memory medium coupled to said processor, wherein said memory medium includes program instructions stored thereon that are executable by said processor to cause said apparatus to receive data using at least one of a stand-alone sensor or a network of sensors using at least one of a wireless communication technology and a wired communication technology.

15. The apparatus of claim 11 further comprising a visualization module to check the legality of the player action using two-dimensional or three-dimensional visualization based on at least one of real-time sensor data or stored sensor data to effectively simulate the player action.

16. The apparatus of claim 11 further comprising a network of sensors capable of transmitting data from different placement configurations of sensors on the player to perform a function of either correctly classifying the player action as legal or illegal or simulating at least one of a two-dimensional or a three-dimensional model of the player action.

17. The apparatus of claim 11 further comprising at least one sensor capable of transmitting sensor data from at least one of a sports implement, a sports article, and a game animal, to either classify the legality of the player action in a game or to simulate at least one of a two-dimensional or a three-dimensional model of the player action.

18. The apparatus of claim 11 wherein said apparatus comprises an overall compact structure and light weight so as to be minimally intrusive to the player action.

19. An article of manufacture including a non-transitory computer-readable storage medium having instructions stored thereon which are executable by a computing device to cause the computing device to perform operations comprising the steps of:
acquiring sensor data from at least one sensing block disposed on a player;
sending said sensor data downstream to a computation and inference block;
receiving said sensor data at said computation and inference block;
storing said sensor data received at said computation and inference block; and
processing said received sensor data to infer the legality of a player action performed in a game.

20. The article of manufacture of claim 19 further comprising the steps of:
processing said previously stored sensor data so as to visualize said player action; and
providing corrective feedback to said player.
